(19) United States
(12) Patent Application Publication
(10) Pub. No.: US 2023/0172168 A1
(43) Pub. Date: Jun. 8, 2023

(54) A FEEDING OR DRINKING DEVICE FOR POULTRY PRODUCTION AND USE HEREOF IN A NUTRITION SYSTEM

(71) Applicant: Light Navigates ApS, Viborg (DK)

(72) Inventor: Carsten Nielsen, Viborg (DK)

(21) Appl. No.: 17/922,835

(22) PCT Filed: May 12, 2021
(86) PCT No.: PCT/DK2021/050151

§ 371 Date: Nov. 2, 2022

(30) Foreign Application Priority Data
May 13, 2020 (DK) PA 2020 70312
May 13, 2020 (EP) 20174392.9
May 13, 2020 (EP) 20174396.0

(51) Int. Cl. A01K 31/00; A01K 39/012; A01K 39/02

(52) U.S. Cl. CPC A01K 31/007; A01K 39/0125; A01K 39/02

(57) ABSTRACT

A plastic member for a feeding system for poultry production is provided. The plastic member includes an outer surface and may be configured for attracting pullets to a specific area. The plastic member may be adapted for application in a feeding system and/or a drinking system. The plastic member may include shining particles configured with reflective characteristic of reflecting incident light in one or more directions. Also provided is a use of the plastic member in nutrition systems and elements herefore.

### CROSS-REFERENCE TO RELATED APPLICATIONS

This application claims priority to PCT Application No. PCT/DK2021/050151, having a filing date of May 12, 2021, which is based DK Application No. PA 2020 70312, having a filing date of May 13, 2020, EP Application No. 20174396.0, having a filing date of May 13, 2020, and EP Application No. 20174392.9, having a filing date of May 13, 2020, the entire contents all of which are hereby incorporated by reference.

### FIELD OF TECHNOLOGY

The following relates to poultry equipment incorporating shining particles. At least within the present application poultry equipment shall be understood as articles and/or materials used in the farming of poultry. The equipment disclosed herein for example comprises feeding or drinking device for a feeding system for poultry production, and/or an additive for a pullet starter feed comprising shining particles configured with reflective characteristic of reflecting incident light and/or is a shining floor cover (10) for poultry production configured for attracting pullets to a specific area (20).

For example, the feeding or drinking device comprises an outer surface and may be configured for attracting pullets to a specific area. The feeding or drinking device may be adapted for application in a feeding system and/or a drinking system. The feeding or drinking device may comprise shining particles configured with reflective characteristics for reflecting incident light in one or more directions. Another example being an additive for a pullet starter feed comprising shining particles configured with reflective characteristic of reflecting incident light in one or more directions, the additive being adapted for being dry-mixed with pullet starter feed, and the shining particles being adapted for maintaining the reflective characteristic in full or partly when dry-mixed with the pullet starter feed. A further example of poultry equipment is a shining floor cover for poultry production configured for attracting pullets to a specific area and adapted for floor application in feeding areas and/or drinking areas, wherein the shining floor cover comprises shining particles configured with reflective characteristic of reflecting incident light in one or more directions.

### BACKGROUND

Today, breeding livestock of poultry includes feeding of freely moving poultry. An essential part of a successful breeding includes that the pullets must eat a substantial amount of feed within twenty-four hours after hatching for reducing any reduction in optimal development and health risks.

Furthermore, an early increase in the weight of the pullets typically also results in a more rapid growth of the pullets and hence a shorter breeding time for the pullets to reach a predetermined slaughter weight, i.e., breeding time being the time from hatching to the time of reaching the predetermined slaughter weight. The period from the pullets are introduced into the stable and again collected for being transported to the slaughterhouse is also called a rotation.

By being able to entice more pullets to eat more particularly during the first 24 hours, it will be achieved that more pullets survive and that a more uniform size distribution of pullets in all stages of their development is achieved.

Typically, more than 50-60,000 pullets are introduced simultaneously into a stable, and by achieving a faster and more uniform growth of the pullets, significantly less pullets will succumb to underdevelopment and death. Although percent-wise the number may be small, the factual number of individual pullets may be significant.

Stimulating the feeding instinct of pullets is therefore of great importance, particularly during the first twenty-four hours.

U.S. Pat. No. 2,630,096 discloses a poultry feeder applying a green light source as a stimuli signal for stimulation of the feeding instinct immediately upon hatching and the development of healthy feeding habits during the early stages of growth.

A common and well-known appliance for attracting the chickens to the feeding area is Chick paper. Chick paper is configured for making a rustling noise when the pullets step on it. The rustling noise attracts the pullets and hence attracts the pullets to approach the feed.

Another critical point in time is when the pullets no longer feed off the yolk. In particular, for chickens this is around day three from hatch where the chicken no longer feeds off the yolk. At this point, the pullets may again need additional stimuli for continuing eating and to further increase in weight.

Solutions for stimulation of the feeding instinct in pullets within the first twenty-four hours and again when the pullets no longer feed off the yolk, is of great interest for a healthy and rapid growth. Furthermore, increasing the weight of the pullet with a few percentages in the first seven days can result in the pullets reaching the appropriate slaughter weight faster and hence a shorter production time from hatching to slaughtering.

A further example from the conventional art is disclosed in US2008/0156271 wherein reflective particles are embedded in material from which for example food cups are manufactured. The reflective particles are indicated as attracting the poultry, but no effect positive or otherwise is demonstrated. As is evident with embodiments of the present invention, too much reflective material (i.e., too much of a surface covered by reflective material may have a detrimental effect). The reflective particles are indicated as having a mean diameter of between 0.9-1 mm. However, the size of the particles as indicated in embodiments of the present invention is not so important as the amount of surface covered by particles. Consequently, as US2008/0156271 does not specifically determine the distribution of the reflective particles, the effect achieved is random and not substantiated. Similar considerations apply to U.S. Pat. No. 6,571,732.

Other examples of enhancing the attraction for poultry to the feeding are disclosed in US2016330930 and US2019037798 where the paper spread in the vicinity of feed and water is provided with a dye, colouring the entire surface in a, for the poultry, attractive colour.

### SUMMARY

An aspect relates to a nutrition system for attracting poultry to a feeding area or a drinking area and in particular to the feeding pans or drip cups.

A further aspect may be to stimulate the pullets' feeding instinct and teaching the pullets where to find nutrition.

Embodiments of the invention disclose the surprising fact that using shining particles or flakes in connection with breeding poultry—particularly during the first days, dramatically increases weight gain, and decreases mortality.

Embodiments of the invention are materialized in various applications of including shining particles or flakes in various equipment such as floor paper, drinking and feeding devices, as well as in the fodder/feed.

Embodiments of the invention thus disclose poultry equipment for poultry production, where the poultry equipment is incorporating shining particles visible on the surface of the poultry equipment, where the shining particles are either obtained as surface coating particles with a shining coating or as flakes either as free flakes or particles or embedded in a material, where the particles or flakes has a mean surface measure between 0.3 mm to 1 mm, and where the area coverage of particles or flakes is between 0.2% and 2% of the (surface of the) poultry equipment.

At least within embodiments of the present invention, as it is also evident from the exemplary embodiments discussed below, poultry equipment is to be understood as anything used in poultry production. For example, floor covering paper used below and around food cups, the food cups and drinking nozzles themselves and also the feedstuff.

Furthermore, flakes are intended to describe particles having an almost two-dimensional shape, whereas particles may have a three-dimensional shape. For example, “corn flakes” are considered to have an almost two-dimensional shape, whereas “nuggets” have a three-dimensional shape.

Also, the sizes of the particles and flakes is important for a number of reasons. Firstly, if the particles are administered such that the poultry may directly eat the particles, these should have a size small enough not to cause any digestion challenges for the poultry. When the particles are embedded in a material, the size should be large enough to be recognized by the poultry, but also small enough not to dominate or introduce detrimental characteristics to the material in which it is embedded.

As will be evident from the discussion below relating to the tests carried out, there is a clear and distinct difference between equipment provided with shining articles and equipment without shining particles. Furthermore, also the amount of shining particles appears to be important, as is evident from the tests carried out in the development of embodiments of the present invention. It is actually evident that too much shining material will deter the pullets from the feed or feeding devices. However, amounts between 0.2% and 2% have returned dramatic effects with respect to weight increase (higher foodstuff intake) providing faster growing chicks, and healthier chicks as indicated by lower mortality rates.

Disclosed herein is a feeding or drinking device for a feeding system for poultry production. The feeding or drinking device comprises an outer surface and may be configured for attracting pullets to a specific area. The feeding or drinking device may be adapted for application in a feeding system and/or a drinking system. The feeding or drinking device may comprise shining particles configured with reflective characteristics for reflecting incident light in one or more directions.

The shining particles may be arranged at or near the outer surface, such that the reflective characteristic is visible in full or partly when exposing the outer surface to light.

In this disclosure pullets may refer to poults, broilers or similar expressions used for a young domestic chicken, turkey, pheasant, or other young fowls raised for food, rearing or breeding.

Breeding may in this disclosure be used as a general term covering rearing and keeping of livestock for food or other purposes.

The reflective characteristics of the shining particles may include sparkling which may be defined as being reflective and shining brightly. A sparkling object may thus have a reflective surface which reflects single or multiple incident wavelengths. A sparkling object may reflect light such that it appears as giving off tiny sparks. A sparkling object may be perceived as being clear and bright, and shining with multiple small points of light. Tinsel, mica, mother of pearl may all be perceived as being shining.

Alternatively, a sparkling object may be perceived as to cause glitter or shine. Thus, the reflective characteristics of the shining particles may include glittering. The shining particles may reflect light with multiple wavelengths or reflect light with wavelengths within one or more selected ranges of wavelengths.

The feeding or drinking device may constitute a drip-cup or a part hereof e.g., a drip nipple, the cup itself, a holder to be coupled to a water line, a feeding pan or a part hereof e.g., a bowl, a funnel or a cone for guiding or holding the feed in the feeding pan, a holder to be coupled to a feed line, distribution blades. These devices are listed as mere examples and are not meant as a full or comprehensive list, thus other parts adapted for a similar use may be included in the general term feeding or drinking device.

Arranging the shining particles at the surface or near the surface has the effect that the particles reflect an amount of light being sufficient to be perceived by the pullets. The amount of light to be reflected may be within a range of 5-100% of the incoming light, alternatively 20-80% or 50-75%.

The feeding area, drinking area or both may include areas where other sources of nutrition, medical substances, drugs or other compositions beneficial in poultry production are made available.

In the following the term nutrition area may be used which includes feeding area, drinking area or both.

One effect of the feeding or drinking device may be to evoke or entice the pullets' attention. The shining particles may reflect light such that the pullets' interest is evoked for approaching a nutrition area. The interest for shining objects is observed for other species of birds e.g., magpies that collect large shining objects.

Attracting the pullets to the nutrition areas may be advantageous in particular in the initial feeding phase of the pullets immediately after hatching for teaching the pullets where to find food and water.

The teaching may be achieved by combining the feeding or drinking device with feed or water. An early teaching of where to find nutrition may lead to healthier and faster weight gaining pullets.

The effects may be considered as nudging the pullets to the nutrition areas. This nudging effect may result in that the pullets are taught where to find the feed; approaching the feeding area may become an entrenched habit.

Feed in the disclosure may include or be limited to water, nutrition, feed pellets, bugs, insects, medical substances, drugs or other compositions beneficial in poultry production.

Another effect of the feeding or drinking device may be that even in dim light the shining may be perceived as being equally intensive to or more intensive than in full light and hence may cause the pullets to continue eating for a longer time. A prolonged eating time may result in a faster weight gain of the pullets. An increase in weight of the pullet with a few percentages within the first seven days and especially within the first 24 hours can result in the pullets reaching the appropriate slaughter weight faster and hence achieving a shorter production time (rotation) from hatching to slaughtering.

Light and pullets' perception hereof is a widely discussed subject. The perceptions of which type of light, for how long and the intensity hereof is best suited for breeding of pullets vary between breeders. However, a general perception in poultry breeding is that the pullets should be exposed to dark periods with a minimum duration of six hours, that bright light can be used in cases where pecking damage and cannibalism do not pose a problem and that very dim lighting may adversely affect ocular development.

Yet a further effect of the feeding or drinking device may arise in cases where pecking damage and cannibalism pose a problem. In this case, a dimmed lighting may be desired. In this case, the shining may be perceived as being equally intensive to, or more intensive than in full light and hence may help to draw the pullets' attention to the nutrition areas and in this way cause the pullets to continue eating even in surroundings with dimmed lighting.

Furthermore, if there is a concern that very dim lighting may adversely affect ocular development by the pullets, the shining particles may help to reduce that risk, as the variation in intensity between the reflected light from the shining particles and the surroundings may help in the ocular development by the pullets.

This may lead to upholding the feeding activity by the pullets, even in cases where the facilities may be exposed to only dimmed lighting.

In one embodiment the feeding or drinking device may comprise a transparent or semi-transparent plastic base material.

One effect of this embodiment may be that the reflective characteristics of the shining particles are utilized even if mixed into the base material. Furthermore, the transparency may allow the pullets to observe nutrition through the plastic member.

In one embodiment, the feeding or drinking device may be an injection molded or a thermoformed plastic part.

Nowadays, thermoforming is a generic term and usually includes vacuum forming, pressure forming and twin sheet forming. In general, thermoforming may refer to any process wherein plastic in a sheet form is heated to a temperature at which it softens and wherein the softened plastic sheet is arranged in a mold and molded herein such that the plastic sheets when cooled maintain the shape of the mold.

One effect of this embodiment may be to use commonly known fabrication process already used for plastic parts. Furthermore, existing molds whether for injection molding or thermoforming of plastic members for feeding systems in pullet productions may be used to achieve the disclosed embodiments of the feeding or drinking device.

In one embodiment of the feeding or drinking device, the plastic base material may be selected from the group comprising polypropylene (PP), polyethylene (PE), polyethylene terephthalate (PET), polymethyl methacrylate (PMMA), polycarbonate (PC), polystyrene (PS) or styrene acrylonitrile (SAN).

These materials are well-known and commonly used plastics for hard plastic parts. The plastic parts should be of a certain hardness for withstanding the pecking of the pullets.

Furthermore, the materials or specific grades hereof possess a general chemical resistance for the detergents used for cleaning or sanitizing facilities for poultry production.

In one embodiment the feeding or drinking device may have an outer surface with a flush surface with a surface roughness, Ra of 0.7 micrometer or less.

The surface roughness should be flushable for easy cleaning/sanitation of the facilities for poultry production.

In one embodiment of the feeding or drinking device, the shining particles may reflect light in the range of 315-750 nm.

In one embodiment of the feeding or drinking device, the shining particles may reflect light in the range of 450-510 nm, in the range of 460-500 nm, in the range of 475-485 nm, in the range of 600-660 nm, in the range of 610-650 nm, in the range of 625-635 nm or a combination hereof.

In one embodiment of the feeding or drinking device, the shining particles may reflect light in the range of 495-570 nm.

The optimal composition of light for breeding poultry may depend on the exact race being bred and the purpose of the breeding e.g., whether it is for faster weight increase, stimulation of egg production or another purpose.

The general perception in regard to chickens is that they can see light with wavelengths in the range of 315-750 nm, and that chickens may see higher peaks at spectrums around 480 and 630 nm. Furthermore, it is by some perceived that green light is beneficial for attracting and stimulating chickens.

One further effect of the embodiments, wherein the reflected light comprises one or more of the visible wavelengths for chickens or other pullets, may be to target the shining effect to the specific race being breed. This may as previously described evoke the pullets' attention to the area wherein the feeding or drinking devices are arranged and attract the pullets to specific areas e.g., the nutrition areas. In addition, the targeted wavelengths may stimulate the eating instinct of the pullets.

Another effect of the embodiments with targeted wavelengths may be to reduce the amount or size of the shining particles, if the reflected wavelengths are within a range for which the pullets have particularly sensitive receptors.

In one embodiment, the feeding or drinking device may have a surface density of visible shining particles on the outer surface of 30 or less particles per cm\hat{ }2 (square centimeter), in the range 20 to 5 particles per cm\hat{ }2.

Visible shining particles may be understood as particles for which the reflective characteristics are observed when looking at the outer surface of the feeding or drinking device. Hence, the light may not be completely attenuated along the light path across the air/plastic boundary and through the plastic to the shining particle and back. The specific depth of particles to be included in the surface density depends on the plastic material i.e., type, grade, color etc. and the reflectiveness of the shining particles.

Thus, the surface density or coverage may be defined as the number of shining particles adding to the visible shining effect. Hence, in one aspect, the shining particles may be positioned inside the plastic, but still contributing with a shining effect and thus be included as in the particles defining the surface density or coverage.

The surface density may if beneficial be greater than the 30 particles per cm\hat{ }2 (square centimeter) or as low as less than 1 particle per cm\hat{ }2 (square centimeter).

The surface density may be given as a mean number for a larger area than 1 cm\hat{ }2. The shining particles may thus be arranged in varying concentrations and as randomly positioned shining particles.

One effect of the embodiment may be to ensure that the shining effect is visible even in cases where some of the shining particles are covered by feed or other nutritional objects.

In one embodiment of the feeding or drinking device, the shining particles may be arranged in a sub area of the plastic member. The sub-area may be a rim or an edge.

Alternatively, the sub-area may be a lower part of the cone, an upper part of a pan or cup, an area near a drip nipple etc. The sub-area may beneficially be arranged as close as possible to where the pullets should approach the nutrition while still being visible for the pullets from a given distance.

In one aspect, the content of the shining particles may vary over an area such that the density of the shining articles increases towards a center point, center line, center area or comparable central feature. This may have an effect of guiding the pullets to the center point, center line, center area or comparable central feature, which may comprise the nutrition.

The shape and size of the shining particles may in particular be adapted according to the specific use e.g., the race of pullets in the production and the base material for maintaining the shining effect when in use.

In one embodiment of the feeding or drinking device, the shining particles may have a mean size of 0.1-3 mm, 0.1-1 mm, or 0.3-0.6 mm.

The parameters linked to the surface area may be key parameters. The size and shape of the particles may influence how evenly the shining particles are distributed in a plastic material or on the surface of a plastic material and the ability to reflect the light.

Spherically shaped particles may for example have a higher weight than flakes but with the same surface area. Hence, the key parameters may include:
Size
Distribution of size
Form
Color
Reflection type
Surface properties
Durability to humidity
Durability to temperature e.g., from fabrication of the plastic member

The shape of the particles and the size may be linked for achieving an optimal shining effect of the particles when used in the feeding or drinking device.

The shining particles may have a spherical shape, which may include “oval” or egg shapes, round, elliptic and may include a surface comprising multiple faces combined into a spherical shape.

The shining particles may be configured as flakes being flat type particles or ‘2D’ particles. These may include circular shaped, square shaped, triangular, hexagonal or other regular or non-regular shapes. The shape of the flakes may be a result of a cut-out process or a resulting shape due to the processing of the flakes.

The mean size of the shining particles is defined as the size of particles, which can pass through a grid with openings of that size.

In one aspect, the shining particles may be semi-transparent. In an alternative aspect, the shining particles may be opaque.

Further disclosed herein is a feeding pan for a feeding system for poultry production comprising a plastic member comprising an outer surface, which plastic member may be configured for attracting pullets to a specific area. The plastic member may comprise shining particles configured with reflective characteristic of reflecting incident light in one or more directions.

Further disclosed herein is a drip cup for a drinking system for poultry production comprising an outer surface, which feeding or drinking device may be configured for attracting pullets to a specific area. The plastic member may comprise shining particles configured with reflective characteristic of reflecting incident light in one or more directions.

The shining particles may be arranged at or near the outer surface such that the reflective characteristic is visible in full or in part when exposing the outer surface to light.

For both the drip cup and the feeding pan the plastic member may be according to any of the previously described embodiments.

The effects and advantages of these embodiments may include those already described either individually or in combination for the feeding or drinking device i.e.:
Evoke the pullets' attention to the nutrition systems comprising the feeding or drinking device and attract the pullets hereto
Utilize the shining effect even under dimmed light conditions,
Prolong the eating time for the pullets for faster weight gain of the pullets, including different cases of lighting conditions,
Expose the pullets to varying intensity between the reflected light from the shining particles and the surroundings.
Teach the pullets where to find food and water through nudging.

Further disclosed herein are various uses.

Disclosed is a use of shining particles in a plastic base material for a feeding or drinking device.

Disclosed is also a use of a feeding or drinking device in a feeding pan for a feeding system for poultry production.

Disclosed is also a use of a feeding or drinking device in a drip cup for a drinking system for poultry production.

The feeding or drinking device may be according to any of the previously described embodiments.

The effects and advantages of these embodiments may include those already described either individually or in combination for the feeding or drinking device i.e.:
Evoke the pullets' attention to the nutrition systems comprising the feeding or drinking device and attract the pullets hereto
Utilize the shining effect even under dimmed light conditions,
Prolong the eating time for the pullets for faster weight gain of the pullets, including different cases of lighting conditions,
Expose the pullets to varying intensity between the reflected light from the shining particles and the surroundings.
Teach the pullets where to find food and water through nudging.

Further effects may include obtaining the feeding or drinking device using well-known materials and fabrication method and equipment. The plastic member may be retrofitted into existing nutrition systems and produced using existing molds.

It is also contemplated treating existing feeding or drinking devices with a coating comprising shining particles, in order to achieve the effects mentioned above.

Embodiments of the invention further disclose an additive for pullet starter feed comprising shining particles which provides the advantages as will be discussed below. The shining particles may be configured with reflective characteristic (reflectance) of reflecting incident light in one or more directions. The additive may be adapted for being dry-mixed with pullet starter feed. The shining particles may furthermore be adapted for maintaining the reflective characteristic in full or partly when dry-mixed with the pullet starter feed.

Strictly speaking reflectance is defined as the proportion of perpendicularly incident light reflected from a component compared to that reflected from a standard of known reflectance. Also used within this meaning in this description and claims. However, the reflectance depends on the emitted light towards the surface and the surfaces' ability the reflect the light.

In this disclosure pullets may refer to poults, broilers or similar expressions used for a young domestic chicken, turkey, pheasant, or other young fowls raised for food, rearing or breeding.

Breeding may in this disclosure be used as a general term covering rearing and keeping of livestock for food or other purposes.

The reflective characteristics of the shining particles may include sparkling, which may be defined as being reflective and shine brightly. A sparkling object may thus have a reflective surface, which reflects single or multiple incident wavelengths. A sparkling object may reflect light such that it appears as giving off tiny sparks. A sparkling object may be perceived as being clear and bright, and shining with multiple small points of light. Tinsel, mica, mother of pearl may all be perceived as being shining.

Alternatively, a sparkling object may, be perceived as to cause glitter or shine. Thus, the reflective characteristics of the shining particles may include glittering.

The shining particles may reflect light with multiple wavelengths or reflect light with wavelengths within one or more selected ranges of wavelengths.

The amount of light to be reflected may be in a range where a sufficient amount is reflected for the pullets between 10-100% of the incoming light, 30-80% or 50-75%.

Pullet starter feed may be perceived as a general term in this disclosure and may include or be limited to nutrition, feed pellets, bugs, insects, medical substances, drugs or other compositions beneficial in poultry breeding. Pullet starter feed may be feed especially configured for newly hatched pullets, thus being the initial or start-up feed to be consumed within the first twenty-four hours of hatching and again, when the pullets no longer feed off the yolk. Nutrition elements may refer to a dry object being one or more of nutrition, feed pellets, bugs, insects, medical substances, drugs or other compositions beneficial in poultry breeding.

One effect of the additive may be to evoke the pullets' attention to the additive or a feed into which it is mixed. The shining particles may reflect light such that the pullets' interest are evoked for approaching the additive or feed. The interest for shining objects is observed for other species of birds e.g., magpies, who collects large shining objects.

Another effect may be to stimulate the pecking instinct of the pullets specifically by use of shining particles. This may be advantageous in the initial feeding phase of the pullets immediately after hatching for increasing or improving the pullets' pecking. The pullets may, in the same process become exposed to the feed if the additive is not directly combined with the feed e.g., if the sparkling additive do not adhere to the feed.

The effects may be considered as nudging the pullets to the feeding areas and the feed. This nudging effect may result in, that the pullets are taught where to find the feed; approaching the feeding area may become an entrenched habit.

These effects may lead to healthier and faster weight gaining pullets.

Furthermore, a change in relative position of a pullet and a shining particle with fixed light sources may cause a change in reflection perceived by the pullet. This effect may be beneficial for evoking the pullets' attention.

Another effect of the poultry feed may be that even in dim light the reflection from the shining particles may be perceived as being equally intensive to or more intensive than in full light and hence, may cause the pullets to continue eating for a longer time. A prolonged eating time may result in a faster weight gain of the pullets. An increase in weight of the poult with a few percentages within the first seven days and especially within the first 24-hours can result in the pullets reaching the appropriate slaughter weight faster and hence achieving a shorter production time from hatching to slaughtering.

Light and pullets' perception hereof is a widely discussed subject. The perceptions of which type of light, for how long and the intensity hereof is best suited for breeding of pullets varies between breeders. However, a general perception in poultry breeding is, that the pullets should be exposed to dark periods with a minimum duration of six hours, that bright light may be used in cases where pecking damage and cannibalism do not pose a problem and that very dim lighting may adversely affect ocular development.

Yet a further effect of the poultry feed may arise in cases where pecking damage and cannibalism pose a problem. In this case, a dimmed lighting may be desired. In this case, the reflection from the shining particles may be perceived as being equally intensive to, or more intensive than in full light and hence, may help to draw the pullets' attention to the feed and in this way, help the pullets to continue eating even in surrounding with dimmed lighting.

Furthermore, if the concern that very dim lighting may adversely affect ocular development by the pullets, the reflection from the shining particles may help to reduce that risk. This may be achieved because the variation in intensity between the reflected light from the poultry feed and the surroundings may help in the ocular development by the pullets.

This may lead to upholding the feeding activity by the pullets, even in cases, where the facilities may be exposed to only dimmed lighting.

The additive having shiny particles may comprise fully or partly in cooperated shiny particles with nutrition or medical elements.

Likewise, the shining particles may have a spherical shape with a mean size between 0.25-3 mm, or between 0.5-2.5 mm.

Pullet starter feed when entering the feeding pans or feeding area may include coarse elements and elements of a floury characteristic. The floury elements may have a tendency to cake-up in the feeding pans. Such caking-up effect in the feeding pans may have a number of drawbacks.

If the feed cakes up in the feeding pans, the pullets may perceive the feeding pans to be empty even though they are partly filled. This may reduce the capacity of perceived accessible feed to the pullets. Furthermore, if the feeding pans are controlled by a weighing system for continuous feed, such a control system may operate falsely due to the residues in the feeding pans. Also, the caked-up feed may be residues which are to be wasted, which may increase costs of the production.

In one aspect, the additive may comprise a content of the shining particles of 0.01%-100% by weight of the additive;
thus, the additive may consist of only the shining particles;
alternatively, the additive may comprise a content of shining particles being just enough for achieving a shining effect of the additive e.g., 0.01-1% by weight of the total weight of additive;
in another alternative, the shining particles may constitute an amount of 1%, 10%, 20%, 50% by weight of the total weight of the additive, amongst others.

The suitable content of the shining particles in the additive may be adapted to the race of pullets, the conditions of the facilities e.g., the lighting conditions, any possible dilution by mixture with other elements or other relevant conditions.

In yet another aspect, the shining particles may comprise food coloring, such as E171 (titanium dioxide) or other additives with comparable effects.

In one embodiment, the additive may be biodegradable. This may be beneficial if using the pullets' droppings as fertilizer or manure.

In one embodiment of the additive, the shining particles may have a spherical shape with a mean size between 0.25-3 mm, or between 0.3-2.5 mm.

In one embodiment of the additive, the shining particles may be configured as flakes with a mean size between 0.1-3 mm, between 0.1-1 mm, or between 0.3-0.6 mm

An initial test method has been established, and initial tests have been performed for comparing shining particles shining effect in feed. Different parameters for the shining particles have been changed and compared.

One finding was, that the weight may not be the key parameter for the distribution of the shining particles in an existing pullet feed. The finding instead suggests that parameters linked to the surface area having the shining effect is a key parameter.

The size and shape of the particles may influence how evenly the shining particles are distributed in a feed, if they concentrate in the lower half of the feed in the feeding pan or in the upper half; the ability to reflect the light; the adhesion of the feed to the surface area.

Spherical shaped particles may for example have a higher weight than flakes but with the same surface area. Key parameters may include:
Size
Distribution of size
Form
Color
Reflection type
Surface adherence for feed
Durability to Humidity
Durability to mechanical wear from e.g., feed and process equipment in the pullet production
Volume/weight.

Other findings includes that the total area and numbers of surfaces in the feed may play a key role, that the shape of particles and the size may be linked for achieving an optimal shining effect of the particles mixed in a feed, that the shape of the particles influences on how the particles are distributed in a coarse part of a feed and in a more floury part of a feed.

Shining particles having a spherical shape may include “oval” or egg shapes, round, elliptic and may include a surface comprising multiple faces combined into a spherical shape. Shining particles having a spherical shape with mean sizes in the range of 0.3-0.6 mm were also found to exhibit an excellent shining effect when mixed into the test feed.

Shining particles configured as flakes being flat type particles or ‘2D’ particles may include circular shaped, square shaped, triangular, hexagonal or other regular or non-regular shapes. The shape of the flakes may be a result of a cut-out process or a resulting shape due to the processing of the flakes.

Typically, the average feed type pellets used in pullet production is 2.5 mm and thus the maximum mean size should be in the same order.

The mean size of the shining particles is defined as the size of particles, which can pass through a grid with openings of that size.

In one aspect, the shining particles may be semi-transparent. In an alternative aspect, the shinning particles may be opaque.

In one embodiment of the additive, the shining particles may reflect light in the range of 315-750 nm.

In one embodiment of the additive, the shining particles may reflect light in the range of 450-510 nm, in the range of 460-500, in the range of 475-485 nm, in the range of 600-660 nm, in the range of 610-650, in the range of 625-635 nm or a combination hereof.

In one embodiment of the additive, the shining particles may reflect light in the range of 495-570 nm.

The optimal composition of light for breeding poultry may depend on the exact race being breed and the purpose of the breeding e.g., whether it is for faster weight increase, stimulation of egg production or another purpose.

The general perception in regard to chickens are, that they can see light with wavelengths in the range of 315-750 nm, and that chickens may see higher peaks at spectrums around 480 and 630 nm. Furthermore, it is by some perceived that green light is beneficial for attracting and stimulating chickens.

One further effect of the embodiments, wherein the reflected light comprises one or more of the visible wavelengths for chickens or other pullets may be to target the shining effect to the specific race being breed. This may as previously described evoke the pullets' attention to the poultry feed. In addition, the targeted wavelengths may stimulate the pecking instinct of the pullets.

Another effect of the embodiments with targeted wavelengths may be to reduce the amount or size of the shining particles, if the reflected wavelengths are within a range for which the pullets have particular sensitive receptors.

In one embodiment of the additive, the shining particles comprises fully or partly coated nutrition elements.

Nutrition elements may as previously described refer to a dry object being one or more of nutrition, feed pellets, bugs, insects, medical substances, drugs or other compositions beneficial in poultry breeding.

One further effect of this embodiment may be that in the pecking act, if the pullets are specifically interested in the shining particles, this may include pecking of the coated nutrition element and the pecking may thus result in eating. An additional effect connected hereto may be that selected nutrition elements may be coated for achieving an increased intake hereof by the pullets.

Further disclosed herein is a pullet starter feed mixture comprising a pullet starter feed and an additive comprising shining particles.

The additive may be according to any of the previously described embodiments in this disclosure of an additive comprising shining particle.

The effects and advantages of this embodiment may include those already described either individually or in combination for the additive i.e.:
evoke the pullets' attention to the feed,
stimulate the pecking instinct of the pullets specifically by use of shining particles,
utilize the shining effect even under dimmed light conditions,
prolong the eating time for the pullets for faster weight gain of the pullets, including different cases of lighting conditions,
expose the pullets to varying intensity between the reflected light from the shining particles and the surroundings.

An additional effect of this embodiment may be that the additive is used in a general starter feed for pullets. This may be beneficial for targeting the feed for the pullets' behavior and may push to the pecking and feeding instincts of the pullets. For example, the additive may be mixed into a general starter feed for the pullets and used for a short time e.g., within the first 24 hours and again for a limited period at the time where the pullets no longer feed off the yolk. Hence, the additive may be mixed and adapted to the specific periods of the pullets' lives, where the feed instinct or pecking instinct beneficially can be pushed.

In another aspect, the additive may also be used in later periods of the pullets' lives e.g., around day 18-20, where it is often observed, that the pullets gradually losses instinct/initiative for eating

In one embodiment of the pullet starter feed mixture, the mean content of the shining particles may be below 0.5% by weight of the pullet starter feed mixture, below 0.1% by weight of the pullet starter feed mixture or below 0.01% by weight of the pullet starter feed mixture.

In one embodiment of the pullet starter feed mixture, the mean content of the shining particles may be at least 1 shining particle pr. 100 ml of pullet starter feed, at least 10 shining particle pr. 100 ml of pullet starter feed, or at least 50 shining particle pr. 100 ml of pullet starter feed.

One further effect of these further embodiments may be to ensure that the shining effect is visible in cases where some of the shining particles are covered e.g., by non-sparkling feed and/or nutrition elements, while achieving to use a limited amount of shining particles, which may reduce any additional cost of using an additive.

Further disclosed herein is use of an additive, comprising shining particles in a pullet starter feed.

The additive may be according to any of the previously described embodiments in this disclosure of an additive comprising shining particle.

One effect of this use may be that a pullet starter feed mixture may be achieved having the effects and advantages already described either individually or in combination for the additive, for the pullet starter feed mixture or a combination hereof i.e.:
achieve the pullet starter feed mixture with a general starter feed for the pullets,
adapting the pullet starter feed mixture to specific periods of the pullets' lives, where the feed instinct or peck instinct beneficially can be pushed,
evoke the pullets' attention to the feed,
stimulate the pecking instinct of the pullets specifically by use of shining particles,
utilize the shining effect even under dimmed light conditions,
prolong the eating time for the pullets for faster weight gain of the pullets, including different cases of lighting conditions,
expose the pullets to varying intensity between the reflected light from the shining particles and the surroundings.

In one embodiment of the use of the additive in a pullet starter feed, the content of the shining particles is below 0.5% by weight of the poultry starter feed and the additive, below 0.1% by weight of the poultry starter feed and the additive, or below 0.01% by weight of the poultry starter feed and the additive.

In one embodiment of the use of the additive in a pullet starter feed, the mean content of the shining particles is at least 1 shining particle per 100 ml of pullet starter feed, at least 10 shining particle per 100 ml of pullet starter feed, or at least 50 shining particle per 100 ml of pullet starter feed.

The additive mixed with the poultry starter feed may be a pullet starter feed mixture according to any of the previously described embodiments of pullet starter feed mixtures in this disclosure.

One further effect of these further embodiments may be to ensure that the shining effect of the resulting pullet starter feed mixture is visible in cases where some of the shining particles are covered e.g., by non-sparkling feed and/or nutrition elements while using a limited amount of additive, which may reduce any additional cost of using an additive.

Further disclosed herein is a method of manufacturing an additive comprising an act of fully or partly coating nutrition elements with a composition adapted to solidify into a surface with reflective characteristic of reflecting incident light in one or more directions.

The additive may be according to any of the previously described embodiments of an additive comprising shining particles being fully or partly coated nutrition elements.

One effect of this method may be that a pullet starter feed mixture can be achieved having the effects and advantages already described either individually or in combination for an additive comprising shining particles being fully or partly coated nutrition elements i.e.
that in the pecking act may directly result in eating, and
that selected nutrition elements may be coated for achieving an increased intake hereof by the pullets.

Further disclosed herein is the use of an additive for medical treatment of poultry, the use is for a poultry feed.

In one aspect, the shining particles may include fully or partly coated medical substance.

As previously described, the feeding area, drinking area or both may include areas whit other sources of nutrition, medical substances, drugs or other compositions beneficial in poultry breeding. Furthermore, the pullet starter feed may be perceived as a general term in this disclosure and may include or be limited to nutrition, feed pellets, bugs, insects, medical substances, drugs or other compositions beneficial in initial poultry breeding. Nutrition elements may refer to a dry object being one or more of nutrition, feed pellets, bugs, insects, medical substances, drugs or other compositions beneficial in poultry breeding.

One effect of this embodiment may be that in the pecking act, if the pullets are specifically interested in the shining particles, this may include pecking of the coated medical substances; and thus, the pecking may result in the pullets consuming the medical substances. An additional effect connected hereto may be that selected nutrition elements may be coated for achieving increased intake hereof by the pullets.

Further disclosed herein is a method of manufacturing the pullet starter feed mixture comprising an act of mixing the additive into an existing pullet starter feed.

The pullet starter feed mixture may be according to any of the previously described embodiments.

A further aspect which has to be considered in the context of embodiments of the present invention is the shiny particles reflective properties (reflectance). When exposing sand grains to sunlight, they are hit with maybe 100,000 lux and appears shiny. However, inside a poultry facility the light is much less, maybe 3-5000 lux, and the materials will appear differently. In the tests carried out leading to embodiments of the present invention, it was clear that sand as such had no measurable effect, whereas shining particles/flakes or granules having traditionally shiny surfaces such as silver, gold and the like distinctively increased the chicks desire to feed and lowered the mortality rate.

A further reason not to use sand is the fact that very young chicks intestine system cannot handle the sand and their feeding rate and weight gain is detrimentally influenced by the presence of sand.

One effect of this use may be that a pullet starter feed mixture may be achieved having the effects and advantages already described either individually or in combination for the additive or for the pullet starter feed mixture i.e.:
evoke the pullets' attention to the feed,
stimulate the pecking instinct of the pullets specifically by use of shining particles,
utilize the shining effect even under dimmed light conditions,
prolong the eating time for the pullets for faster weight gain of the pullets, including different cases of lighting conditions,
expose the pullets to varying intensity between the reflected light from the shining particles and the surroundings,
use the pullets droppings as fertilizer or manure.

### BRIEF DESCRIPTION

Some of the embodiments will be described in detail, with references to the following Figures, wherein like designations denote like members, wherein:

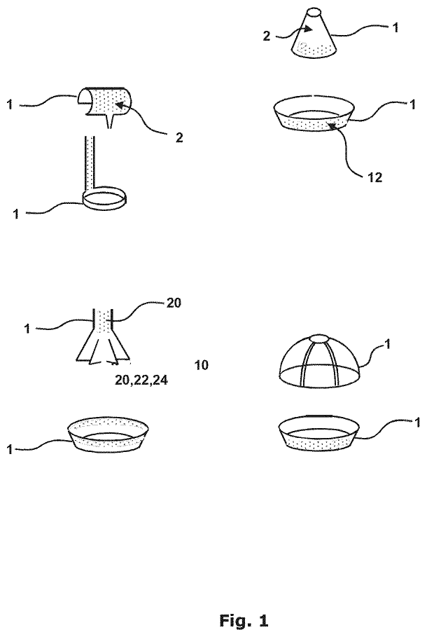

FIG. 1 illustrates various embodiments of the feeding or drinking devices;

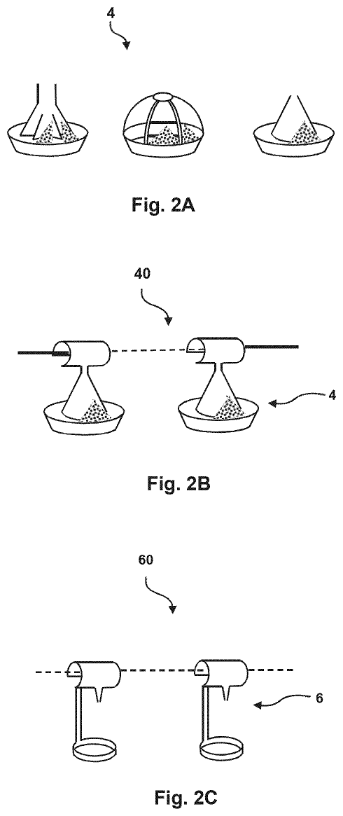

FIG. 2A illustrates embodiments of drinking pans, drip cups and nutrition systems comprising these;

FIG. 2B illustrates embodiments of drinking pans, drip cups and nutrition systems comprising these;

FIG. 2C illustrates embodiments of drinking pans, drip cups and nutrition systems comprising these;

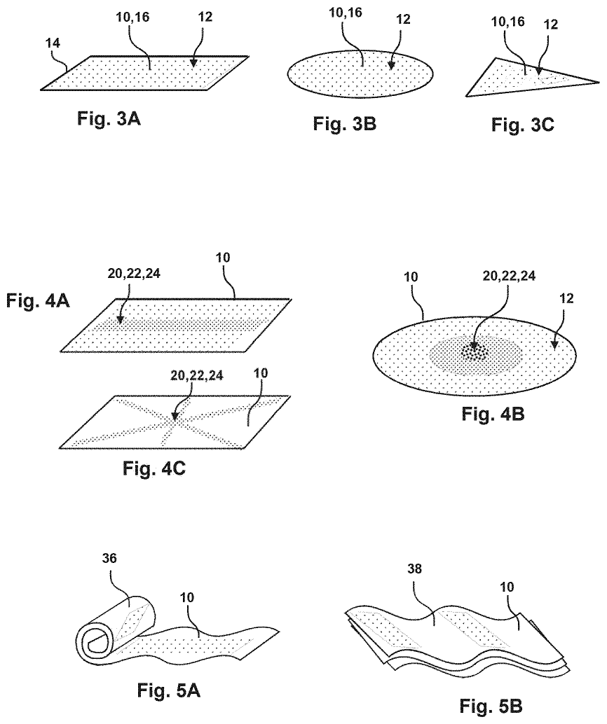

FIG. 3A illustrates an embodiment of the shining floor cover having a first geometric shape;

FIG. 3B illustrates an embodiment of the shining floor cover having another geometric shape;

FIG. 3C illustrates an embodiment of the shining floor cover having another geometric shape;

FIG. 4A illustrates an embodiment of the shining floor cover having a first density of shining particles;

FIG. 4B illustrates an embodiment of the shining floor cover having another density of shining particles;

FIG. 4C illustrates an embodiment of the shining floor cover having another density of shining particles;

FIG. 5A illustrates an embodiment of shining floor cover manufactured as a web or sheets;

FIG. 5B illustrates an embodiment of shining floor cover manufactured as a web or sheets;

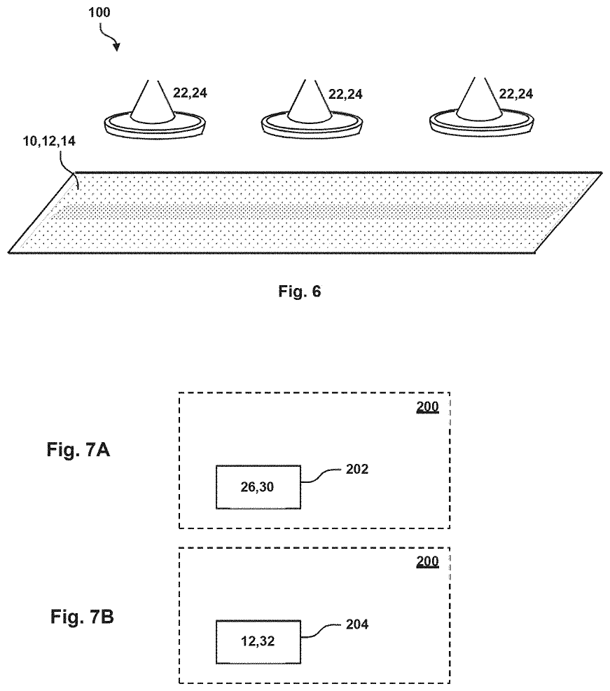

FIG. 6 illustrates one embodiment of the use of the shining floor cover;

FIG. 7A illustrates an embodiment of manufacturing methods of the shining floor cover;

FIG. 7B illustrates an embodiment of manufacturing methods of the shining floor cover;

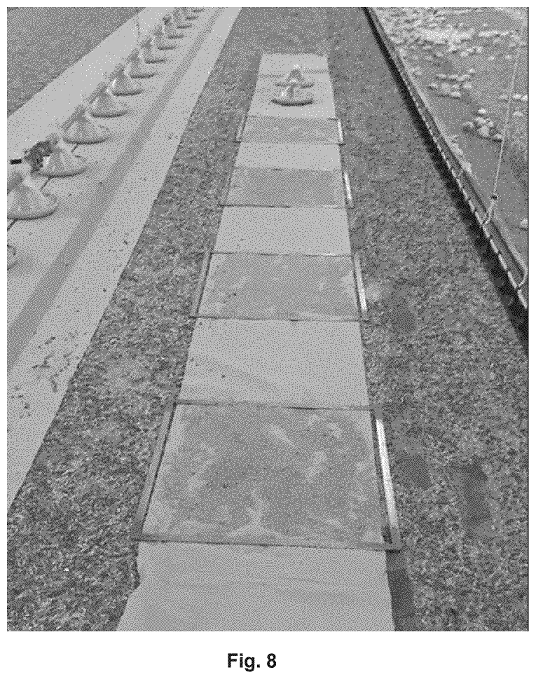

FIG. 8 is a picture from inside a poultry facility with four distinct test fields;

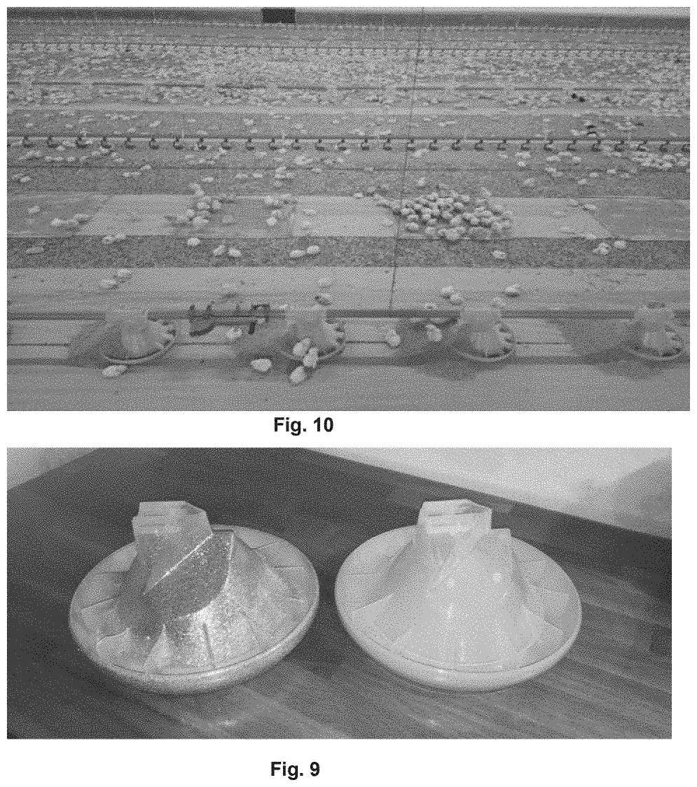

FIG. 9 is a picture of feeding pans;

FIG. 10 is a picture from a breeding facility indicating chicken density;

FIG. 11 is a table depicting the actual measurements; and

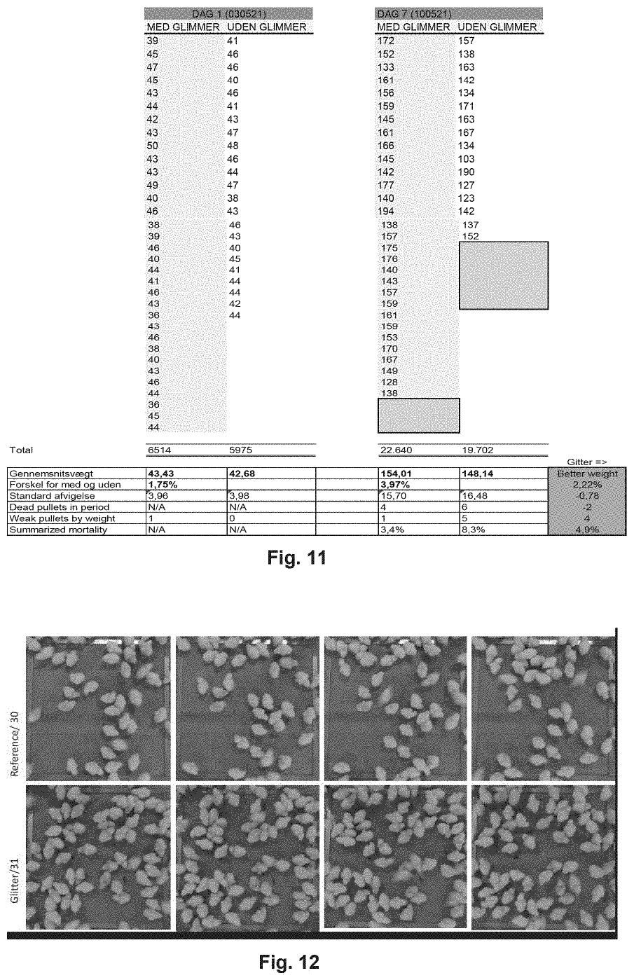

FIG. 12 illustrates a series of comparable photos with or without shiny particles.

### LIST OF REFERENCE NUMBERS

1 feeding or drinking device
2 outer surface
4 feeding pan
6 drip cup
12 shining particles
20 subarea/specific area
40 drinking system
60 feeding system
10 shining floor cover
12 shining particles
14 chick paper
16 geometric FIG.
22 feeding area
24 drinking area
26 surface
30 mixture
32 material
36 sheet
38 web
100 use
200 method
202 coating
204 mixing

### DETAILED DESCRIPTION

Exemplary examples will now be described more fully hereinafter with reference to the accompanying drawings. In this regard, the present examples may have different forms and should not be construed as being limited to the descriptions set forth herein. Accordingly, the examples are merely described below, by referring to the figures, to explain aspects.

The drawings are not made to scale. The thicknesses of layers and areas may be illustrated in an enlarged manner for clarity and ease of description thereof. When an item is referred to as being “arranged on” another item, it may be arranged directly on the other item or intervening items may be present there between. Conversely, when a layer, area, element, or plate is referred to as being “directly on” another item, there are no intervening items there between. Further, when an item is referred to as being “below” another item, it may be directly below the other layer, or intervening items may be present there between. Conversely, when an item is referred to as being “directly below” another item, there are no intervening items there between. The previous also applies to similar spatial relative terms, this also includes ‘connect to’ and ‘directly connected to’.

The spatially relative terms “lower” or “bottom” and “upper” or “top”, “below”, “beneath”, “less”, “above”, and the like, may be used herein for ease of description to describe the relationship between one element or component and another element or component as illustrated in the drawings. It will be understood that the spatially relative terms are intended to encompass different orientations of the device in use or in operation

FIG. 1 illustrates various embodiments of the feeding or drinking device 1. The feeding or drinking devices may constitute a drip-cup or a part hereof e.g., a drip nipple, the cup itself, a holder to be coupled to a water line, a feeding pan or a part hereof e.g., a bowl, a funnel or a cone for guiding or holding the feed in the feeding pan, a holder to be coupled to a feed line, distribution blades.

The shining particles may be arranged in varying concentrations and as randomly positioned shining particles in the plastic member 1. The shining particles should be arranged such that the shining particles are visible on the outer surface 2. For optimal usage, the shining particles should be visible when the feeding or drinking device is in use in the pullet production, i.e., the feed in a feeding pan should not cover the entire area comprising the shining particles 12.

The shining particles 12 may be arranged in a sub-area 20 of the feeding or drinking devices 1 i.e., on a rim or an edge or in a sub-area close to the where the food or water is located in the nutrition systems. Hence, the shining particles may be arranged at a lower part of a cone, an upper part of a pan or cup, in an area near a drip nipple etc. The shining particles may beneficially be arranged as close as possible to where the pullets should approach the nutrition, while still being visible for the pullets from a given distance.

FIG. 2 illustrates various embodiments of drinking pans, drip cups and nutrition systems comprising these.

FIG. 2A illustrates different embodiments of feeding pans 4 holding a small amount of feed. The illustrated feeding pans comprise a bowl and a distribution top. The illustrated embodiments include some well-known types. FIG. 2B illustrates the use of one of these feeding pans in one embodiment of a feeding system 40. A feeding system may comprise multiple feeding pans 4 and a feed supply line (dashed line) comprising a pipe for guiding the feed to the feeding pans 4.

FIG. 2C illustrates one embodiment of a drip cup 6 comprising a bowl for holding water, a drip nipple, and a holder for coupling the drip cup to a water supply line. The illustration is meant as a general depiction of well-known types of drip cups. FIG. 2C furthermore illustrates the use of the drip cups in one embodiment of a drinking system 60. A drinking system may comprise multiple drip cups 6 and a water supply line (dashed line) comprising a pipe for guiding the water to the drip cups 6.

FIG. 3 illustrates three embodiments of the shining floor cover 10 each having a particular geometric FIG. 16 and comprising shining particles 12 with a given surface density. FIG. 1A illustrates the shining floor cover 10 with a rectangular shape. FIG. 1B illustrates the shining floor cover 10 with a circular shape. FIG. 1C illustrates the shining floor cover 10 with a triangular shape. Other geometric figures may be used for the shining floor cover 10, if suitable for the facilities.

The three embodiments of the shining floor cover 10 are all illustrated with a more or less uniform surface density and with a density being the same for the three embodiments. This is only for illustrative purposes and hence, the surface density could vary between the three embodiments and from one shining floor cover 10 with a rectangular shape to another shining floor cover 10 with also a rectangular shape; and likewise for other geometric shaped floor covers 10.

The shining floor covers 10 may comprise chick paper 14 with shining particles 12, as illustrated in FIG. 1A

FIG. 2 illustrates three embodiments of the shining floor cover 10 having different surface densities of shining particles 12. The surface density of each floor cover 10 may vary within that floor cover 10.

FIG. 2A illustrates a rectangular floor cover 10 with a surface density of shining particles 12, which increases towards a center line. This may have an effect of guiding the pullets to a specific area 20, here the center line. In a further embodiment not illustrated here, a number of feeding pans, drinking pans or other nutrition sources may be arranged e.g., above that line i.e., the center line may be a feeding area 22 or a drinking area 24.

FIG. 2B illustrates a circular floor cover 10 with a surface density of shining particles 12, which increases towards a center area or point. This may have an effect of guiding the pullets to a specific area 20, here the center area. In a further embodiment not illustrated here, one or more feeding pans, drinking pans or other nutrition sources may be arranged e.g., above that area.

FIG. 2C illustrates a rectangular floor cover 10 with a surface density of shining particles 12, which increases towards a center area or point. This may have an effect of guiding the pullets to a specific area 20, here the center area. In a further embodiment not illustrated here, one or more feeding pans, drinking pans or other nutrition sources may be arranged e.g., above that area.

FIG. 3 illustrates two embodiments of shining floor cover 10 manufactured as a web 36 or sheets 38.

FIG. 4 illustrates one embodiment of the use 100 of the shining floor cover 10. In the illustrated embodiment, the floor cover 10 has a graded surface density of shining particles 12, which density increases from one edge of the floor cover 10 towards a center line of the floor cover 10 and decreases again towards the opposite edge of the floor cover 10. The illustrated floor cover 10 may comprise chick paper 14, which may be characteristic in that it makes a rustling noise when the pullets step on it, is highly absorbent e.g., of bird droppings amongst other parameters previously described herein. The illustrated floor cover 10 in this embodiment is comparable to the embodiment illustrated in FIG. 2A, where the surface density of shining particles 12 increases towards a center line. This may have an effect of guiding the pullets to the center line where a number of feeding pans 22, drinking pans 24 or other nutrition sources may be arranged e.g., above the center line as illustrated here.

Other floor covers 10 could be illustrated for this embodiment of a use including those illustrated in any of FIGS. 1A-C, 2A-C, 3A, 3B amongst others. Depending on the form of the surface density, one or more feeding pans 22, drinking pans 24 or other nutrition sources may be arranged accordingly.

FIG. 5 illustrates two embodiments of methods 100 of manufacturing the shining floor cover 10.

FIG. 5A illustrates a method comprising an act of coating 202 a surface 26 with a mixture 30 comprising the shining particles. The coating may be suitable for being applied directly onto the surface of a floor, a surface of a chick paper, or another suitable material. In case the mixture is applied to a material, which may be subject for the pullets to ruin when pecking and possibly to eat due to the pecking, the material providing the surface may be a zootechnical additive. These materials/compounds are defined as additives to foodstuff which does not damage or inhibit the digestion of animals eating such additives.

FIG. 5A illustrates a method comprising an act of mixing 204 the shining particles 12 into a material 32 adapted to be manufactured into flexible sheets or webs of shining floor cover. In case the material of the web or sheets may be subject for the pullets to ruin is due to pecking and possibly to eat due to the pecking, the material may be biodegradable.

With reference to FIG. 8 is illustrated a picture from a poultry facility. Nearest the photographer is field no. 1 and furthest field no 4. In the back of the picture is two feeding pans seen, which will be discussed with reference to FIG. 9.

The test was conducted by allowing the chicks to freely roam the area and feed freely from anywhere in the facility.

Start in all fields 1, 5l of feed.

22 hours after start of test “free feeding”:
Field 1—Reference 1,401 Remaining 1 dl, Reference 100% consumption
Field 2—Sphere, 25 g PME, 1,151 Remaining 3.5 dl+250% Consumption
Field 3—Glitter paper, 1,201 Remaining (15% box) 3 dl, +200% Consumption
Field 4—Spray Coated feed, 1,201 Remaining 3 dl, +200% Consumption

The four fields 1-4 are different with respect to the type of shining/reflective material and how it is applied in the field. In field 1 there is no shining/reflective material provided, and the feeding pattern is normal, corresponding to 100% consumption of expected consumption.

In field 2 spheres of shining/reflective material is mixed with the foodstuff, in a ratio corresponding to between 1% and 2% of the area covered by foodstuff and spheres. The spheres themselves has a mean particle size similar to the foodstuff.

In field 3, the paper on which the foodstuff is spread is covered with shining/reflective particles, corresponding to a coverage of 0.2-2% of the paper's area. The chickens will only see the shining/reflective particles through the dispersion of foodstuff.

In field 4 the foodstuff has been spray coated with shining/reflective material prior to being dispensed onto the field. The spray coating corresponds to a cover of 0.5-2% in average of each food particles surface. The spray coating is effected by conveying the foodstuff past a (liquid) spray device, whereby the shining/reflective particles are transferred to the food stuff particles in a process similar to spray painting.

In FIG. 9 is illustrated two feeding pans 124, 126 where one is more or less covered with shining material, and the other bare. The pan with shining material almost scared the chicks away and no positive effect on the feeding or mortality rate was measured/detected. The untreated pan provided a normal feeding pattern. There is a clear correlation between the use of shining material in the right doses/amounts and the well-being and growth of the chicks.

In FIG. 10 are the fields mentioned above with reference to FIG. 8 photographed in use. Field 1 to the right and field 4 to the left. At the time when the photo was taken, it is clear that the chicks preferred field 2 and 3. Field 2 is the field where shining/reflective particles in the shape of spheres are mixed with the foodstuff. The shining/reflective particles have a size corresponding to, but not larger than the foodstuff particles. The amount of shining/reflective particles corresponds to a coverage of between 1-2%.

In FIG. 11 is indicated a table setting out measurements for weight gains for chicks feeding from equipment with shiny particles/flakes (“med glimmer”) and without shiny treatment (“Uden glimmer”). The various numbers listed in columns refer to the chick weights at the particular day (day 1 or day 7).

In FIG. 12 is illustrated photos taken from above parts of the floor in the stable. Above normal chicken paper and below chicken paper with shiny particles. It is easily detectable that there is an increased density of chickens on the chicken paper with shiny particles.

In addition to a substantial and faster weight gain of the chicks, being exposed to equipment with shining particles/flakes, the mortality rate was also much lower, indicating better conditions for the chickens. A further feature detected was the fact that the initially weaker chicks, “learned” to feed with the equipment incorporating shiny particles, and as such in addition to a higher individual weight gain, also the overall weight gain was increased, and more chickens survived.

Although the present invention has been disclosed in the form of embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements. The mention of a “unit” or a “module” does not preclude the use of more than one unit or module.

1. A poultry equipment for poultry production, where the poultry equipment is incorporating shining particles visible on the surface of the poultry equipment, where the shining particles are either obtained as surface coating particles with a shining coating or as flakes either as free flakes or particles or embedded in a material, where the particles or flakes have a mean surface measure between 0.3 mm to 1 mm, and where the area coverage of particles or flakes is between 0.2% and 2% of the surface of the poultry equipment.

2. The poultry equipment according to claim 1, wherein the poultry equipment is a feeding or drinking device comprising an outer surface and configured for attracting pullets to a specific area and configured for application in a feeding system and/or drinking system, wherein the feeding or drinking device comprises shining particles configured with reflective characteristic for reflecting incident light in one or more directions, the shining particles arranged at or near the outer surface of the feeding or drinking device, such that the reflective characteristic is visible in full or in part when exposing the outer surface of the feeding or drinking device to light.

3. The poultry equipment according to claim 1, comprising a transparent or semi-transparent plastic base material.

4. The poultry equipment according to claim 1, wherein the plastic base material is selected from the group comprising polypropylene, polyethylene, polyethylene terephthalate, polymethyl methacrylate, polycarbonate, polystyrene or styrene acrylonitrile.

5. The poultry equipment according to claim 1, wherein the poultry equipment has an outer surface with a flush surface with a surface roughness, Ra of 0.7 micrometer or less.

6. The poultry equipment according to claim 1, wherein the shining particles light in the range of 315-750 nm, in the range of 495-570 nm or where the shining particles reflect lights in different spectra, such that one type of shining particles reflect light in the range of 450-510 nm, whereas another type of shining particles reflect light in the range of 460-500 nm, a still further type of shining particles reflect light in the range of 600-660 nm, a still further type of shining particles reflect light in the range of 610-650 nm and where the shining particles may optionally be combined such that various shining particles which reflect light in different ranges may be combined.

7. The poultry equipment according to claim 1, with a surface density of visible shining particles on the outer surface of the poultry equipment is 10 or less particles per cm\hat{ }2 (square centimeter), in the range 1 to 5 particles per cm\hat{ }2.

8. The poultry equipment according to claim 1, wherein the poultry equipment is an additive for a pullet starter feed comprising shining particles configured with reflective characteristic of reflecting incident light in one or more directions, the additive being configured for being sprinkled on top of the starter feed or being dry-mixed with pullet starter feed, and the shining particles being configured for maintaining the reflective characteristic in full or partly when dry-mixed with the pullet starter feed.

9. The poultry equipment according to claim 8, wherein the additive is biodegradable.

10. The poultry equipment according to claim 8, wherein the equipment is a pullet starter feed mixture wherein the mean content of the shining particles is below 0.5% by weight of the pullet starter feed mixture, below 0.1% by weight of the pullet starter feed mixture, or 0.01% by weight of the pullet starter feed mixture, and where the pullet starter feed mixture optionally may contain the additive.

11. The poultry equipment according to claim 10, wherein the mean content of the shining particles is at least 5 shining particle pr. 100 ml of pullet starter feed, at least 10 shining particle pr. 100 ml of pullet starter feed, even more at least 30 shining particle pr. 100 ml of pullet starter feed.

12. The poultry equipment according to claim 1, wherein the poultry equipment is a shining floor cover for poultry production configured for attracting pullets to a specific area and configured for floor application in feeding areas and/or drinking areas, wherein the shining floor cover comprises shining particles configured with reflective characteristic of reflecting incident light in one or more directions.

13. The poultry equipment according to claim 1, wherein the equipment is provided with a surface density of the shining particles of 10 or less particles per cm\hat{ }2 (square or less particles per cm\hat{ }2.

14. The poultry equipment according to claim 12, wherein the shining particles are arranged to shape a geometric figure configured to be arranged with an orientation such that the geometric figure points toward a specific area.

15. The poultry equipment according to claim 1, wherein the shining particles (12) have a mean size of 0.3-3 mm, 0.3-1 mm, even more 0.3-0.6 mm.

16. The poultry equipment according claim 1, wherein the shining particles reflectance >=45% for light wavelengths in the range from 400 nm to 750 nm.
